(19) United States
(12) Patent Application Publication
(10) Pub. No.: US 2022/0261638 A1
(43) Pub. Date: Aug. 18, 2022

(54) MORE ROBUST TRAINING FOR ARTIFICIAL NEURAL NETWORKS

(71) Applicant: Robert Bosch GmbH, Stuttgart (DE)

(72) Inventors: Frank Schmidt, Leonberg (DE); Torsten Sachse, Koeln (DE)

(21) Appl. No.: 17/625,286

(22) PCT Filed: Jun. 17, 2020
(86) PCT No.: PCT/EP2020/066772

§ 371 Date: Feb. 3, 2022

(30) Foreign Application Priority Data
Jul. 10, 2019 (DE) 10 2019 210 167.4

(51) Int. Cl. G06N 3/08

(52) U.S. Cl. CPC G06N 3/08

(57) ABSTRACT

A method for training an artificial neural network (ANN), that includes a multiplicity of processing units. Parameters that characterize the behavior of the ANN are optimized with the goal that the ANN maps learning input variable values as well as possible onto associated learning output variable values as determined by a cost function. The output of at least one processing unit is multiplied by a random value x and subsequently supplied as input to at least one further processing unit. The random value x is drawn from a random variable with a probability density function containing an exponential function in |x−q| that decreases as |x−q| increases, where q is a freely selectable position parameter and |x−q| is contained in the argument of the exponential function in powers |x−q|^{k} where k≤1. A method for operating an ANN is also described.

### FIELD

The present invention relates to the training artificial neural networks, for example for use as a classifier and/or as a regressor.

### BACKGROUND INFORMATION

Artificial neural networks, or ANNs, are designed to map input variable values onto output variable values as determined by a behavior rule specified by a set of parameters. The behavior rule is not defined in the form of verbal rules, but rather by the numerical values of the parameters in the parameter set. During the training of the ANN, the parameters are optimized in such a way that the ANN maps learning input valuable values as well as possible onto associated learning output variable values. The ANN is then expected to correctly generalize the knowledge it acquired during the training. That is, input variable values should then also be mapped onto output variable values that are usable for the respective application even when they relate to unknown situations that did not occur in the training.

In such a training of the ANN, there is a fundamental risk of overfitting. This means that the ANN learns the correct mapping of the learning input variable values onto the learning output variable values with a high degree of perfection “by rote,” at the cost of faulty generalization to new situations.

G. E. Hinton, N. Srivastava, A. Krizevsky, I. Sutskever, R. S. Salakhutdinov, “Improving neural networks by preventing co-adaptation of feature detectors,” arXiv:1207.0580 (2012), describes the deactivation, during the training, of half of the available processing units in each case according to a random design, in order to prevent overfitting and to achieve a better generalization of the knowledge acquired during training.

S. I. Wang, C. D. Manning, “Fast dropout training,” Proceedings of the 30^{th} International Conference on Machine Learning (2013), describes that the processing units not be completely deactivated, but rather multiplied by a random value obtained from a Gaussian distribution.

### SUMMARY

In accordance with the present invention, a method is provided for training an artificial neural network, ANN. The ANN includes a multiplicity of processing units that can correspond for example to neurons of the ANN. The ANN is used to map input variable values onto output variable values that are useful for the respective application.

Here, the term “values” is not to be understood as limiting with regard to the dimensionality. Thus, an image can be for example represented as a tensor made up of three color layers, each having a two-dimensional array of intensity values of individual pixels. The ANN can take this image as a whole as an input variable value, and can for example assign it a vector of classifications as output variable value. This vector can for example indicate, for each class of the classification, the probability or confidence with which an object of the corresponding class is present in the image. The image can here have a size of for example at least 8×8, 16×16, 32×32, 64×64, 128×128, 256×256 or 512×512 pixels, and can have been recorded by an imaging sensor, for example a video, ultrasonic, radar, or lidar sensor, or by a thermal imaging camera. The ANN can in particular be a deep neural network, i.e. can include at least two hidden layers. The number of processing units is preferably large, for example greater than 1000, preferably greater than 10,000.

The ANN can in particular be embedded in a control system that, as a function of the ascertained output variable values, provides a control signal for the corresponding controlling of a vehicle and/or of a robot and/or of a production machine and/or of a tool and/or of a monitoring camera and/or of a medical imaging system.

In the training, parameters that characterize the behavior of the ANN are optimized. The goal of this optimization is for the ANN to map learning input variable values as well as possible onto associated learning output variable values, as determined by a cost function.

In accordance with an example embodiment of the present invention, the output of at least one processing unit is multiplied by a random value x and is subsequently supplied as input to at least one further processing unit. Here, the random value x is drawn from a random variable with a previously defined probability density function. This means that a new random value x results with every drawing from the random variable. Given the drawing of a sufficiently large number of random values x, the observed frequency of these random values x approximately maps the previously defined probability density function.

The probability density function is proportional to an exponential function in |x−q| whose magnitude decreases as the magnitude of |x−q| increases. In the argument of this exponential function, |x−q| is contained in powers |x−q|^{k} where k≤1. Here, q is a freely selectable position parameter that defines the position of the mean value of the random variable.

It has been found that, surprisingly, this suppresses the tendency to overfitting even better than the cited conventional methods. That means that an ANN trained in this way is better able to ascertain, for the respective application, output variable values that lead to the goal when it is given input variable values that relate to situations that are so far unknown.

One application in which ANNs have to rely to a particular degree on their power of generalization is the at least partly automated driving of vehicles in public roadway traffic. Analogous to the training of human drivers, who, before their test, usually spend fewer than 50 hours behind the wheel and drive fewer than 1000 km, ANNs also have to make do with training on a limited set of situations. The limiting factor here is that the “labeling” of learning input variable values, such as camera images from the surrounding environment of the vehicle, with learning output variable values, such as a classification of the objects visible in the images, in many cases requires human input, and is correspondingly expensive. At the same time, for safety it is indispensable that a car encountered in traffic that has an unusual design is still recognized as a car, and that a pedestrian is not classified as a surface that can be driven over simply because he or she is wearing a piece of clothing with an unusual pattern.

Thus, in these and other safety-relevant applications, a better suppression of the overfitting has the consequence that the output variable values outputted by the ANN can be trusted to a higher degree, and that a smaller set of learning data is required to achieve the same level of safety.

In addition, the better suppression of the overfitting also results in the improvement of the robustness of the training. A technically important criterion for robustness is the extent to which the quality of the training result is a function of the initial state from which the training was started. Thus, the parameters that characterize the behavior of the ANN are usually randomly initialized and then successively optimized. In many applications, such as the transfer of images between domains each of which represents different image styles, with the use of generative adversarial networks it can be difficult to predict whether a training starting from a random initialization will provide a finally usable result. Trials carried out by applicant have shown here that in many cases a plurality of attempts are necessary until the training result is usable for the respective application.

In this situation, a better suppression of overfitting saves computing time spent on unsuccessful attempts, and thus also saves energy and money.

A cause of the better suppression of the overfitting is that the variability contained in the learning input variable values, of which the capacity of the ANN for generalization is a function, is increased by the random influencing of the processing units. The probability density function having the described properties here has the advantageous effect that the influencing of the processing units produces fewer contradictions to the “ground truth” used for the training and that is embodied in the labeling of the learning input variable values with the learning output variable values.

In accordance with an example embodiment of the present invention, the limitation of the powers |x−q|^{k} of |x−q| to exponents k≤1 counteracts, to a particular degree, the occurrence of singularities during the training. The training is frequently carried out using a gradient descent method in relation to the cost function. This means that the parameters that characterize the behavior of the ANN are optimized in a direction in which better values of the cost function are to be expected. The formation of gradients however requires a differentiation, and here, for exponents k>1, it turns out that the absolute value function is not differentiable around 0.

In a particularly advantageous embodiment of the present invention, the probability density function is a Laplace distribution function. This function has a sharp, pointed maximum in its center, but the probability density is however continuous even at this maximum. The maximum can for example represent a random value x of 1, i.e., an unmodified forwarding of the output of the one processing unit as input to the further processing unit. Around the maximum, a large number of random values x are then concentrated that lie close to 1. This means that the outputs of a large number of processing units are only slightly modified. In this way, the stated contradictions with the knowledge contained in the labeling of the learning input variable values with the learning output variable values are advantageously suppressed.

In particular, the probability values L_{b}(x) of the Laplace distribution function can for example be given by:

$${L}_{b} ( x ) = \frac{1}{2 b} exp ( - \frac{\vert x - q \vert}{b} ) with$$

$$b = \sqrt{\frac{p}{2 - 2 p}} and 0 \leq p < 1.$$

Here, q is, as described above, the freely selectable position parameter of the Laplace distribution. If this position parameter is for example set to 1, the maximum of the probability density L_{b}(x), as described above, is assumed to be x=1.

The scaling parameter b of the Laplace distribution is expressed by the parameter p, and the range that is appropriate for the provided application is hereby normed to the range 0≤p<1.

In a particularly advantageous embodiment of the present invention, the ANN is built from a plurality of layers. For those processing units in at least one layer whose outputs are, as described above, multiplied by a random value x, the random values x are drawn from one and the same random variable. In the example cited above, in which the probability density of the random values x is Laplace-distributed, this means that the value of p is uniform for all processing units in the at least one layer. This takes into account the circumstance that the layers of the ANN represent different processing levels of the input variable values, and the processing is massively parallelized by the multiplicity of processing units in each layer.

For example, the various layers of an ANN that is designed to recognize features and images can be used to recognize features having different complexity. Thus, for example in a first layer basic elements can be recognized, and in a second, following layer, features can be recognized that are composed of these basic elements.

The various processing units of a layer thus work with the same type of data, so that it is advantageous to take modifications of the tasks through the random values x within a layer from one and the same random variable. Here, the different tasks within a layer are usually modified with different random values x. However, all random values x drawn within a layer are distributed according to the same probability density function.

In a further particularly advantageous embodiment of the present invention, after the training the accuracy with which the trained ANN validation input variable values are mapped onto associated validation output variable values is ascertained. The training is repeated multiple times, in each case with random initialization of the parameters.

Here, particularly advantageously most, or in the best case all, validation input variable values are not contained in the set of learning input variable values. The ascertaining of the accuracy is then not influenced by possible overfitting of the ANN.

The variance over the degrees of accuracy ascertained in each case after the individual trainings is ascertained as a measure of the robustness of the training. The less the degrees of accuracy differ from one another, the better the robustness, according to this measure.

It is not guaranteed that the trainings starting from different random initializations will in the end result in the same or similar parameters characterizing the behavior of the ANN. Two trainings started one after the other may also provide completely different sets of parameters as results. However, it is ensured that the ANN characterized by the two sets of parameters will behave in a qualitatively similar manner when applied to the validation data sets.

The quantitative measurement of the accuracy in the described manner provides further points of approach for an optimization of the ANN and/or its training. In a further particularly advantageous embodiment, either the maximum power k of |x−q| in the exponential function or the value of p in the Laplace probability density L_{b}(x) is optimized, with the goal of improving the robustness of the training. In this way, the training can be still better tailored to the intended application of the ANN without having to know in advance a specific effective relation between the maximum power k, or the value of p, on the one hand, and the application on the other hand.

In a further particularly advantageous embodiment of the present invention, at least one hyperparameter that characterizes the architecture of the ANN is optimized with the goal of improving the robustness of the training. Hyperparameters can relate for example to the number of layers of the ANN and/or to the type and/or to the number of processing units in each layer. In this way, with regard to the architecture of the ANN the possibility is also created of replacing human development work at least partly by automated machine work.

Advantageously, the random values x are each kept constant during the training steps of the ANN, and are newly drawn from the random variable between the training steps. A training step can in particular include the processing of at least one subset of the learning input variable values to form output variable values, comparing these output variable values with the learning output variable values as determined by the cost function, and feeding back the knowledge acquired therefrom into the parameters that characterize the behavior of the ANN. Here, this feeding back can take place for example through successive back-propagation through the ANN. In particular for such a back-propagation, it is appropriate if the random value x at the respective processing unit is the same value that was also used in the forward propagation in the processing of the input variable values. The derivation used in the back-propagation of the function represented by the processing unit then corresponds to the function that was used in the forward propagation.

In a particularly advantageous embodiment of the present invention, the ANN is designed as a classifier and/or as a regressor. In a classifier, the improved training brings it about that in a new situation that did not occur in the training, the ANN will, with a higher probability, supply the classification that is correct in the context of the specific application. Analogously, a regressor provides a (one-dimensional or multidimensional) regression value that is closer to the correct value, in the context of the specific application, of at least one variable sought by the regression.

The results improved in this way can in turn have advantageous effects in technical systems. The present invention therefore also relates to a combined method for training and operating an ANN.

In accordance with an example embodiment of the present invention, in this method, the ANN is trained with the method described above. Subsequently, measurement data are supplied to the trained ANN. These measurement data are obtained through a physical measurement process and/or through a partial or complete simulation of such a measurement process, and/or through a partial or complete simulation of a technical system observable using such a measurement process.

In particular such measurement data have the property that, in them, constellations frequently occur that were not contained in the learning data used for the training of the ANN. For example, a very large number of factors influence how a scene observed by a camera is translated into the intensity values of a recorded image. If one and the same scene is observed at different times, images will therefore be recorded that, with a probability bordering on certainty, are not identical. Therefore, it is also to be expected that each image occurring during the use of the trained ANN will differ at least to a certain degree from all images that were used in the training of the ANN.

The trained ANN maps the measurement data, obtained as input variable values, onto output variable values, such as onto a classification and/or regression. As a function of these output variable values, a control signal is formed, and a vehicle and/or classification system and/or a system for quality control of mass-produced products, and/or a system for medical imaging, are controlled using the control signal.

In this context, the improved training has the effect that, with high probability, the controlling of the respective technical system that is triggered is the one that is appropriate for the respective application and the current state of the system represented by the measurement data.

The result of the training is embodied in the parameters that characterize the behavior of the ANN. The set of parameters that includes these parameters and was obtained using the method described above can be immediately used to put an ANN into the trained state. In particular, ANNs having the behavior improved by the training described above can be reproduced as desired once the parameter set is obtained. Therefore, the parameter set is an independently marketable product.

The described methods can be completely or partly computer-implemented. Therefore, the present invention also relates to a computer program having machine-readable instructions that, when they are executed on one or more computers, cause the computer or computers to carry out one of the described methods. In this sense, control devices for vehicles and embedded systems for technical devices that are also capable of executing machine-readable instructions are also to be regarded as computers.

The present invention also relates to a machine-readable data carrier and/or to a download product having the computer program. A download product is a digital product transmissible over a data network, i.e., downloadable by a user of the data network, that can be offered for sale, for example for immediate download in an online shop.

In addition, a computer can be equipped with the set of parameters, the computer program, the machine-readable data carrier, and/or the download product.

Further measures that improve the present invention are presented in the following together with the description of the preferred exemplary embodiments of the present invention, on the basis of the figures.

### BRIEF DESCRIPTION OF THE DRAWINGS

FIG. 1 shows an exemplary embodiment of method 100 for training an ANN 1, in accordance with the present invention.

FIG. 2 shows an example of a modification of tasks 2b of processing units 2 in an ANN 1 having a plurality of layers 3a-3c, in accordance with the present invention.

FIG. 3 shows an exemplary embodiment of the combined method 200 for training an ANN 1 and for operating the ANN 1* trained in this way, in accordance with the present invention.

### DETAILED DESCRIPTION OF EXAMPLE EMBODIMENTS

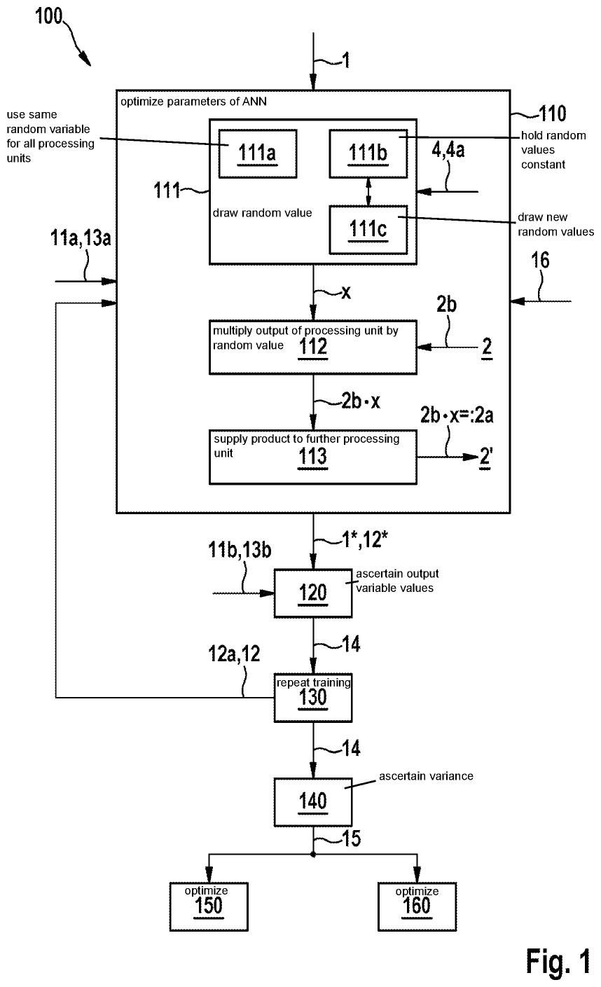

FIG. 1 is a flow diagram of an exemplary embodiment of method 100 for training ANN 1. In step 110, parameters 12 of an ANN 1 defined in its architecture are optimized, with the aim of mapping learning input variable values 11a as well as possible onto learning output variable values 13a, as determined by cost function 16. As a result, ANN 1 is put into its trained state 1*, which is characterized by optimized parameters 12*.

For clarity, the conventional optimization from the related art in accordance with cost function 16 is not further explained in FIG. 1. Instead, in box 110 it is shown only how access is had to this conventional process in order to improve the result of the training.

In step 111, a random value x is drawn from a random variable 4. This random variable 4 is statistically characterized by its probability density function 4a. If many random values x are drawn from the same random variable 4, the probabilities with which the individual values of x occur on average are described by density function 4a.

In step 112, the output 2b of a processing unit 2 of ANN 1 is multiplied by random value x. In step 113, the thus formed product is supplied to a further processing unit 2′ of ANN 1, as input 2a.

Here, according to block 111a within a layer 3a-3c of ANN 1, in each case the same random variable 4 can be used for all processing units 2. According to block 111b, the random values x during the training steps of the ANN 1 are held constant, which steps can include, in addition to the mapping of learning input variable values 11a onto output valuable values 13, the successive back-propagation of the error ascertained by cost function 16 through ANN 1. Random values x can then be newly drawn from random variable 4 between the training steps, according to block 111c.

The one-time training of ANN 1 according to step 110 already improves its behavior in the technical application. This improvement can be further increased if a plurality of such trainings are carried out. This is shown in more detail in FIG. 1.

In step 120, after the training the accuracy 14 with which trained ANN 1* maps validation input variable values 11b onto associated validation output variable values 13b is ascertained. In step 130, the training is repeated multiple times, in each case with random initialization 12a of parameters 12. The variance over the degrees of accuracy 14, ascertained in each case after the individual training, is ascertained in step 140 as a measure of the robustness 15 of the training.

This robustness 15 can be evaluated in itself in any manner in order to derive a statement about the behavior of ANN 1. However, robustness 15 can also be fed back into the training of ANN 1. In FIG. 1, two possibilities of this are indicated as examples.

In step 150, the maximum power k of |x−q| in the exponential function, or the value of p in the Laplace probability density L_{b}(x), can be optimized with the aim of improving the robustness 15. In step 160, at least one hyperparameter that characterizes the architecture of the ANN can be optimized with the aim of improving robustness 15.

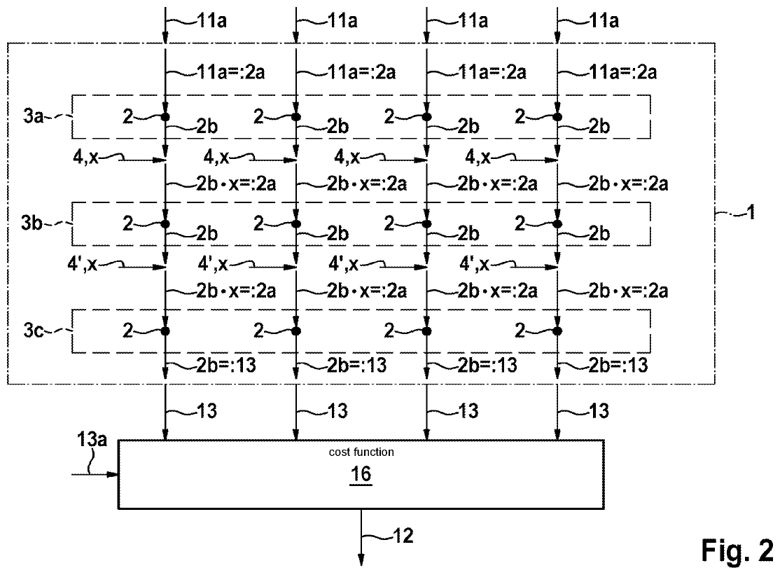

FIG. 2 shows as an example how the outputs 2b of processing units 2 in an ANN 1 having a plurality of layers 3a-3c can be influenced by random values x drawn from random variable 4, 4′. In the example shown in FIG. 2, ANN 1 is made up of three layers 3a-3c each having four processing units 2.

Input variable values 11a are supplied to the processing units 2 of first layer 3a of ANN 1 as inputs 2a. Processing units 2, whose behavior is characterized by parameters 12, produce outputs 2a that are intended for processing units 2 of the respectively next layer 3a-3c. Outputs 2b of processing units 2 in the last layer 3c at the same time form output variable values 13, provided as a whole by ANN 1. For readability, for each processing unit 2 only a single handover to a further processing unit 2 is shown in each case. In the real ANN 1, output 2b of each processing unit 2 in a layer 3a-3c typically goes, as input 2a, to a plurality of processing units 2 in the following layer 3a-3c.

Outputs 2b of processing units 2 are each multiplied by random values x, and the respectively obtained product is supplied to the next processing unit 2 as input 2a. Here, for outputs 2b of processing units 2 of first layer 3a, random value x is in each case drawn from a first random variable 4. For the outputs 2b of processing units 2 of second layer 3b, random value x is drawn in each case from a second random variable 4′. For example, the probability density functions 4a that characterize the two random variables 4 and 4′ can be differently scaled Laplace distributions.

The output variable values 13 onto which the ANN maps the learning input variable values 11a are compared, during the evaluation of cost function 16, with learning output variable values 13a. From this, modifications of parameter 12 are ascertained with which, in the further processing of learning input variable values 11a, better evaluations by cost function 16 can be expected to be obtained.

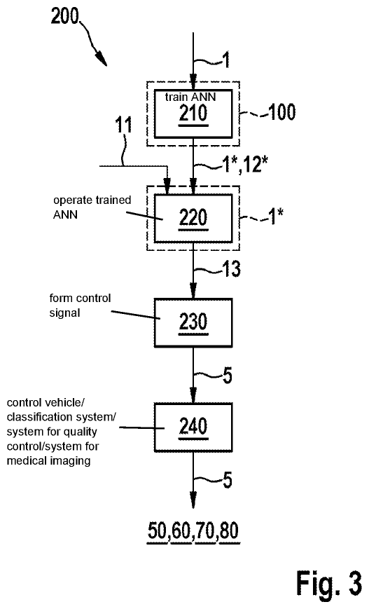

FIG. 3 is a flow diagram of an exemplary embodiment of the combined method 200 for training an ANN 1 and for the subsequent operation of the thus trained ANN 1*.

In step 210, ANN 1 is trained with method 100. ANN 1 is then in its trained state 1*, and its behavior is characterized by optimized parameters 12*.

In step 220, the finally trained ANN 1* is operated, and maps input variable values 11, which include measurement data, onto output variable values 13. In step 230, a control signal 5 is formed from the output variable values 13. In step 240, a vehicle 50, and/or a classification system 60, and/or a system 70 for quality control of mass-produced products, and/or a system 80 for medical imaging, are controlled using control signal 5.

1-14. (canceled)

15. A method for training an artificial neural network (ANN) that includes a multiplicity of processing units, the method comprising:
optimizing parameters that characterize a behavior of the ANN with a goal that the ANN maps learning input variable values onto associated learning output variable values as well as possible as determined by a cost function;
multiplying an output of at least one processing unit of the processing units by a random value x and subsequently supplying the multiplied output as input to at least one further processing unit of the processing units, the random value x being drawn from a random variable with a previously defined probability density function, the probability density function being proportional to an exponential function in |x−q| that decreases as |x−q| increases, where q is a freely selectable position parameter and |x−q| is contained in an argument of an exponential function in powers |x−q|^{k} where k≤1.

16. The method as recited in claim 15, wherein the probability density function is a Laplace distribution function.

17. The method as recited in claim 16, wherein the probability density L_{b}(x) of the Laplace distribution function is given by:
$${L}_{b} ( x ) = \frac{1}{2 b} exp ( - \frac{\vert x - q \vert}{b} ) with$$
$$b = \sqrt{\frac{p}{2 - 2 p}} and 0 \leq p < 1.$$

18. The method as recited in claim 15, wherein the ANN is built from a plurality of layers and, for the processing units in at least one of the layers, the random values x being drawn from the same random variable.

19. The method as recited in claim 17, wherein:
after the training an accuracy with which the trained ANN maps validation input variable values onto associated validation output variable values is ascertained,
the training is repeated multiple times with, in each case, random initialization of the parameters, and
a variance over degrees of accuracy, ascertained after each of the trainings, is ascertained as a measure of robustness of the training.

20. The method as recited in claim 19, wherein the maximum power k of |x−q| in the exponential function or the value of p in the Laplace probability density L_{b}(x) is optimized with a goal of improving the robustness of the training.

21. The method as recited in claim 19, wherein at least one hyperparameter that characterizes an architecture of the ANN is optimized with a goal of improving the robustness of the training.

22. The method as recited in claim 15, the random value x is held constant during the training steps of the ANN, and being newly drawn from the random variable between the training steps.

23. The method as recited in claim 15, wherein the ANN is a classifier and/or as a regressor.

24. A method for training and operating an artificial neural network (ANN), comprising:
training the ANN by:
optimizing parameters that characterize a behavior of the ANN with a goal that the ANN maps learning input variable values onto associated learning output variable values as well as possible as determined by a cost function, and
multiplying an output of at least one processing unit of the processing units by a random value x and subsequently supplying the multiplied output as input to at least one further processing unit of the processing units, the random value x being drawn from a random variable with a previously defined probability density function, the probability density function being proportional to an exponential function in |x−q| that decreases as |x−q| increases, where q is a freely selectable position parameter and |x−q| is contained in an argument of an exponential function in powers |x−q|^{k} where k≤1;
supplying the trained ANN with measurement data, as input variable values, that were obtained through a physical measurement process and/or through a partial or complete simulation of the measurement process and/or through a partial or complete simulation of a technical system observable by the measurement process,
forming a control signal as a function of output variable values supplied by the trained ANN; and
controlling, with the control signal, a vehicle and/or a classification system and/or a system for quality control of mass-produced products and/or a system for medical imaging.

25. A parameter set having parameters that characterize a behavior of an artificial neural network (ANN) that includes a multiplicity of processing units obtained by:
optimizing parameters that characterize a behavior of the ANN with a goal that the ANN maps learning input variable values onto associated learning output variable values as well as possible as determined by a cost function;
multiplying an output of at least one processing unit of the processing units by a random value x and subsequently supplying the multiplied output as input to at least one further processing unit of the processing units, the random value x being drawn from a random variable with a previously defined probability density function, the probability density function being proportional to an exponential function in |x−q| that decreases as |x−q| increases, where q is a freely selectable position parameter and |x−q| is contained in an argument of an exponential function in powers |x−q|^{k} where k≤1.

26. A non-transitory machine-readable data carrier on which is stored a computer program including machine-readable instructions for training an artificial neural network (ANN) that includes a multiplicity of processing units, the instructions, when executed by one or more computers, causing the one or more computers to perform the following steps:
optimizing parameters that characterize a behavior of the ANN with a goal that the ANN maps learning input variable values onto associated learning output variable values as well as possible as determined by a cost function;
multiplying an output of at least one processing unit of the processing units by a random value x and subsequently supplying the multiplied output as input to at least one further processing unit of the processing units, the random value x being drawn from a random variable with a previously defined probability density function, the probability density function being proportional to an exponential function in |x−q| that decreases as |x−q| increases, where q is a freely selectable position parameter and |x−q| is contained in an argument of an exponential function in powers |x−q|^{k} where k≤1.

27. A computer configured to train an artificial neural network (ANN) that includes a multiplicity of processing units, the computer configured to:
optimize parameters that characterize a behavior of the ANN with a goal that the ANN maps learning input variable values onto associated learning output variable values as well as possible as determined by a cost function;
multiply an output of at least one processing unit of the processing units by a random value x and subsequently supplying the multiplied output as input to at least one further processing unit of the processing units, the random value x being drawn from a random variable with a previously defined probability density function, the probability density function being proportional to an exponential function in |x−q| that decreases as |x−q| increases, where q is a freely selectable position parameter and |x−q| is contained in an argument of an exponential function in powers |x−q|^{k} where k≤1.
